(19) United States
(12) Patent Application Publication
(10) Pub. No.: US 2008/0153453 A1
(43) Pub. Date: Jun. 26, 2008

(54) Method for providing emergency service in WiMAX networks

(75) Inventor: Alexander Bachmutsky, Sunnyvale, CA (US)

Correspondence Address: SQUIRE, SANDERS & DEMPSEY L.L.P., 8000 TOWERS CRESCENT DRIVE, 14TH FLOOR, VIENNA, VA, 22182-2700, US

(73) Assignee: NOKIA CORPORATION

(21) Appl. No.: 11/641,971

(22) Filed: Dec. 20, 2006

(51) Int. Cl. H04M 11/04; H04L 12/28

(52) U.S. Cl. 455/404.1; 370/389

(57) ABSTRACT

A method and apparatus includes a transmitting unit configured to transmit a packet to a dedicated destination internet protocol address, wherein the packet includes a request with an emergency service indication. The mobile station also includes a receiving unit configured to receive an incoming packet for an emergency service call, wherein the incoming packet is destined to a source address of the mobile station and wherein the source address of one a designated IP address or a current IP address of the mobile station. The receiving unit is configured to receive the incoming packet through a service flow and the mobile station is thereby configured to minimize signalling with a network before the mobile station begins an emergency service call.

### BACKGROUND OF THE INVENTION

1. Field of the Invention

The present invention relates to method and apparatus for enabling a WiMAX subscriber to establish a quick session, with minimal signalling, when connecting to either a home or visited emergency service access point.

2. Description of the Related Art

Providing emergency services is a mandatory requirement in many existing networks, whether fixed or mobile, where voice services are provided. Support for emergency services requires schemes for handling, for example, emergency services call detection, location services, callback services, support for unauthenticated subscribers, routing to the nearest Public Safety Answering Point (PSAP), providing preferential treatment for emergency calls at all levels of the network and handling of Denial of Service attacks.

A Worldwide Interoperability for Microwave Access (WiMAX) technology was developed by the WiMAX Forum to promote conformance and interoperability of the IEEE 802.16 standard. Mobile WiMAX is a broadband wireless solution that enables convergence of mobile and fixed broadband networks through a common wide area broadband radio access technology and flexible network architecture. The Mobile WiMAX Air Interface adopts Orthogonal Frequency Division Multiple Access (OFDMA) for improved multi-path performance in non-line-of-sight environments.

Usually a mobile station initiates an emergency call by dialling a pre-configured destination number, for example, 911 in the United States. The problem is that different countries have different numbers for activating emergency services. There is currently a mechanism to download different emergency numbers into the mobile station. However, existing technologies usually limit the number of emergency numbers that may be downloaded to the mobile station. Once a number is downloaded, these technologies are configured to enable acceptance of a call to one of the downloaded numbers as an emergency service call, even if the local emergency number is different from the calling number. However, these technologies cannot ensure that networks, for example in the United State, will recognize all emergency service numbers of a visiting terminal. For example, these technologies cannot ensure that networks in the United States will recognize an emergency service number from a small country in Africa.

In the WiMAX forum, there have been discussions about how emergency services can be accessed by mobile stations implementing the WiMAX technology. However, standards associated with how emergency services are to be accessed have not been formally adopted by the WiMAX forum. Nevertheless, universal access to emergency services is now one of requirements from mobile telecommunication operators.

### SUMMARY OF THE INVENTION

The present invention relates to a mobile station including a transmitting unit configured to transmit a packet to a network emergency services designated destination internet protocol address, wherein the packet includes a request with an emergency service indication. The mobile station also includes a receiving unit configured to receive an incoming packet for an emergency service call, wherein the incoming packet is destined to a destination address of the mobile station and wherein the destination address of the incoming packet is one of a mobile station designated emergency service IP address or a current IP address of the mobile station, if previously allocated. The receiving unit is configured to receive the incoming packet through a service flow and the mobile station is thereby configured to minimize signalling with a network before the mobile station begins an emergency service call.

The invention also relates to a base station including a receiving unit configured to receive a packet from a mobile station to a network emergency services designated destination internet protocol (IP) address, wherein the packet includes a request with an emergency service indication. The base station also includes an identifying unit configured to identify the packet as an emergency service call based on the emergency service indication, an emergency packets handling unit configured to process emergency packets with a highest priority and an indication unit configured to indicate to a gateway that the packet is an emergency service call. The base station further includes a transmitting unit configured to transmit an emergency packet for the emergency service call to the mobile station, wherein the emergency packet is destined to a current mobile station IP address or to a mobile station designated emergency service IP address which is different from network emergency services designated IP address. The transmitting unit is configured to transmit the emergency packet through a service flow, thereby minimize signalling with the mobile station when the mobile station begins an emergency service call.

The invention also relates to a gateway including a receiving unit configured to receive an indication from a base station to a network emergency service designated destination internet protocol address, wherein the network emergency service designated destination internet protocol address is an implicit indication of emergency service use. The gateway also includes an emergency service handling unit configured to provide prioritized handling of the packet internally in the gateway, a determining unit configured to determine if the mobile station is assigned an internet protocol address, an address allocation unit configured to pre-allocate one or more unique IP addresses for emergency calls and an translating unit corresponding to the address allocation unit configured to translate a mobile station emergency service designated IP address associated with the mobile station and a dynamically assigned unique IP address used for a particular emergency call, when the a IP address is not previously assigned to the mobile station. The gateway further includes a selection unit configured to select a public safety answering point in a visited network or a home network and a corresponding translation unit configured to translate network emergency service designated IP address into the selected public safety answering point destination IP address.

The invention also relates to a method including transmitting a packet to a network emergency services designated destination internet protocol address, wherein the packet includes a request with an emergency service indication. The method also includes receiving an incoming packet for an emergency service call, wherein the incoming packet is destined to a destination address of the mobile station and wherein the destination address of one a designated IP address or a current IP address of the mobile station. The incoming packet is received through a service flow and the mobile station is thereby configured to minimize signalling with a network before the mobile station begins an emergency service call.

The invention also relates to a method including receiving a packet from a mobile station to a network emergency services designated destination internet protocol address, wherein the packet includes a request with an emergency service indication. The method also includes identifying the packet as an emergency service call based on the emergency service indication, processing emergency packets with a highest priority and indicating to a gateway that the packet is an emergency service call. The method further includes indicating to a gateway that the packet is an emergency service call and transmitting an emergency packet for the emergency service call to the mobile station, wherein the emergency packet is destined to a source address of the mobile station. The emergency packet is transmitted through a service flow, thereby minimize signalling with the mobile station when the mobile station begins an emergency service call.

The invention also relates to a method including receiving an indication from a base station to a network emergency service designated destination internet protocol address, wherein the network emergency service designated destination internet protocol address is an implicit indication of emergency service use. The method also includes providing prioritized handling of the packet internally in the gateway, determining if the mobile station is assigned an IP address and translating a designated IP address, pre-allocating one or more unique IP addresses for emergency calls and translating a mobile station emergency service designated IP address and a dynamically assigned unique IP address used for a particular emergency call, when a IP address is not previously assigned to the mobile station. The method further includes selecting a public safety answering point in a visited network or a home network and translating network emergency service designated IP address into the selected public safety answering point destination IP address.

The invention also relates to an apparatus including transmitting means for transmitting a packet to a network emergency services designated destination internet protocol address, wherein the packet includes a request with an emergency service indication. The apparatus also includes receiving means for receiving an incoming packet for an emergency service call, wherein the incoming packet is destined to a destination address of the mobile station and wherein the destination address of the incoming packet is one of a mobile station designated emergency service IP address or a current IP address of the mobile station, if previously allocated. The incoming packet is received through a service flow and the mobile station is thereby configured to minimize signalling with a network before the mobile station begins an emergency service call.

The invention also relates to an apparatus including receiving means for receiving a packet from a mobile station to a network emergency services designated destination internet protocol address, wherein the packet includes a request with an emergency service indication. The apparatus also includes identifying means for identifying the packet as an emergency service call based on the emergency service indication, processing means for processing emergency packets with a highest priority and indicating means for indicating to a gateway that the packet is an emergency service call. The apparatus further includes transmitting means for transmitting an emergency packet for the emergency service call to the mobile station, wherein the emergency packet is destined to a current mobile station IP address or to a mobile station designated emergency service IP address which is different from network emergency services designated IP address. The invention also relates to an apparatus including receiving means for receiving an indication from a base station to a network emergency service designated destination internet protocol address, wherein the network emergency service designated destination internet protocol address is an implicit indication of emergency service use. The apparatus also includes providing means for providing prioritized handling of the packet internally in the gateway, determining means for determining if the mobile station is assigned an internet protocol address, pre-allocating means for pre-allocating one or more unique IP addresses for emergency calls and translating means for translating a mobile station emergency service designated IP address and a dynamically assigned unique IP address used for a particular emergency call, when a IP address is not previously assigned to the mobile station. The apparatus also includes selecting means for selecting a public safety answering point, in a visited network or a home network and for translating network emergency service designated IP address into the selected public safety answering point destination IP address.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention, wherein:

FIG. 1 illustrates an End-to-End WiMAX Network System Architecture;

FIG. 2 illustrates a data flow diagram implementing the steps implemented in embodiments of the invention;

FIG. 3 illustrates a data flow diagram implementing the steps implemented in embodiments of the invention when there is an initial service flow, pre-established data paths and pre-registered mobile IP;

FIG. 4 illustrates the steps implemented by a mobile station implementing embodiments of the invention;

FIG. 5 illustrates the steps implemented by a base station implementing embodiments of the invention;

FIG. 6 illustrates the steps implemented by a gateway implementing embodiments of the invention;

FIG. 7 illustrates the steps implemented, in a downlink direction, by a gateway implementing embodiments of the invention; and

FIG. 8 illustrates the steps implemented, in a downlink direction, by a base station implementing embodiments of the invention.

### DETAILED DESCRIPTION OF PREFERRED EMBODIMENTS

Reference will now be made to the preferred embodiments of the present invention, examples of which are illustrated in the accompanying drawings. The present invention provides a method and apparatus for enabling a WiMAX subscriber to establish a quick session, with minimal signalling, when connecting to either a home or visited emergency service access point.

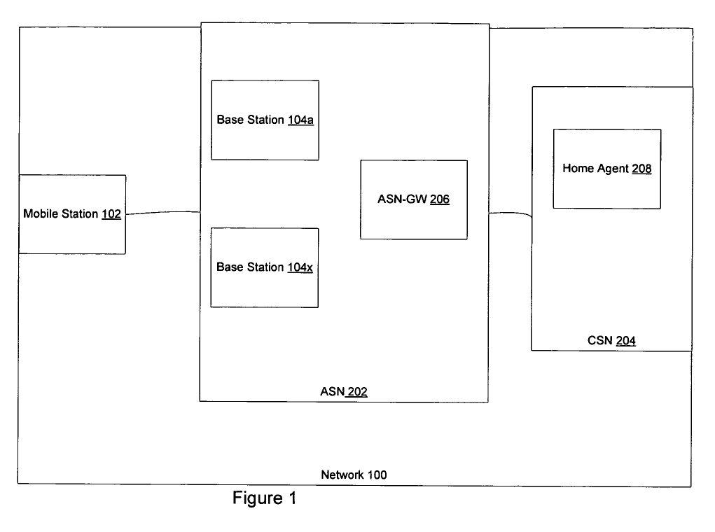

FIG. 1 illustrates an End-to-End WiMAX Network System Architecture 100. FIG. 1 illustrates a mobile station 102 connected to a Access Services Network (ASN) 202 which is connected to a Connectivity Services Network (CSN) 204. ASN 202 include multiple base stations 104a-104x and an ASN gateway (ASN-GW) 206. ASN-GW 206 may serve as a foreign agent. CSN 204 includes at least one home agent 208.

An embodiment of the present invention uses a network emergency services designated destination IP address, which may be a reserved multicast or unicast address, to enable mobile station 102 to access emergency services. For example, mobile station 102 can be designed to include a dedicated button, a pre-programmed function button or a user-configured number so that an end user action can cause mobile station 102 to send packets to the network emergency services designated destination IP address.

Mobile station 102 may also include a source IP address which is an authenticated and received IP address from the network. However, if mobile station does not have a source IP address, that is, the mobile station has not been authenticated with the network and/or a previous IP address allocation fail for any reason, emergency services may be still enabled. In the latter case, mobile station 102 may use an agreed upon mobile station emergency services designated IP address which is different from the network emergency services designated IP address. The designated network emergency service IP address may be either standardized or configured in all WiMAX networks to allow easier emergency services implementation in a roaming scenario. The mobile station emergency service designated IP address will later be translated by the network into a unique IP address to be used for this particular emergency service call. Therefore, the present invention minimizes signalling between mobile station 102 and WiMAX network before the mobile station starts emergency services call.

To receive incoming packets for an emergency services call, mobile station 102 can process packets destined to either its current IP address or to the mobile station emergency services designated IP address, or both.

While it is assumed that there is at least initial Service Flow (ISF) available for mobile station 102, it is not necessary for the mobile station to have initial service flow to implement the invention. If such flow is not available, mobile station 102 may send a request with an emergency services indication. In an embodiment of the invention, the request may be encoded in DSA-REQ. Emergency services may then be delivered either through the initial service flow or through separate (new or existing) service flow (SF). Mobile station 102 may accept requests for Quality of Service (QoS) setting for such service flow. QoS modification for the existing service flow might happen even after the emergency call is established.

An embodiment of the present invention also provides a capability to address either a visited public safety answering point (PSAP) or a home PSAP. The PSAP is a physical location where emergency telephone calls are received and then routed to the proper emergency services. The following example is used to point out the functionality associated with addressing a home or visited PSAP. Currently, there are many Internet-based services for IP terminals. For example, an end-user can install a home security monitoring system and receive a video call from the home security system when intrusion is detected. If in such scenario the end-user is roaming, even in different country, the user is likely to want to call his home PSAP instead of a visited PSAP to alert his home police department. Therefore, in the present invention mobile station 102 may indicate the desire to call either visited or home PSAP using different network emergency services designated IP addresses. However, the home PSAP call may only be possible when mobile station 102 is fully authenticated with a home network and the PSAP destination IP address is provided as a part of the mobile subscriber's profile. This ensures that the home PSAP is not misused by the mobile station for non-emergency activities. If the home PSAP access is requested and the address of home PSAP is not available or the home PSAP cannot be reached, the call may be routed to a visited PSAP. In the example above, an emergency service call may be made in addition to existing calls, for example a call monitoring home video security feed, instead of dropping all existing calls. The mobile station includes a transmitting unit configured to transmit a packet to a network emergency service designated destination IP address wherein the source IP address is either a current mobile station IP address (if previously allocated) or the mobile station designated emergency service IP address that is different from a network designated emergency IP address. The network emergency service designated IP address in the packet may be used as an emergency service indication. The transmitting unit can send emergency packets either through an initial service flow or other Service Flow. The mobile station also includes a receiving unit configured to receive an incoming packet for an emergency service call. The destination address of the incoming packet is either a mobile station designated emergency service IP address or a current IP address of the mobile station, if previously allocated. It should be noted that the network emergency designated IP address may be a home or visited network emergency service designated IP address.

Once an emergency call is placed by mobile station 102, base station 104 includes a receiving unit configured to receive the packet from mobile station 102 destined to a network emergency service designated destination internet protocol address. Base station 104 identifies the emergency service call based on emergency services indications in DSA-REQ or based on the network emergency service designated IP address. Base station 104 also includes an emergency packets handling unit that processes emergency packets with highest priority and an indication unit configured to indicate to a gateway that the packet is an emergency service call. Such gateway indication can be implicit by the fact of forwarding packet with network emergency service designated destination address to the gateway with or without transport (L2 and/or L3) level indication through the means of priority and/or DSCP fields use or explicit by using pre-configured Service Flow that is dedicated for emergency packets. Base station 104 forwards the emergency service call to ASN-GW 206, including any requests for access to a home or visited PSAP. If there is no existing service flow to mobile station 102, base station 104 may use the initial service flow or create a separate service flow for connectivity to mobile station 102. In any case, base station 104 may attempt setting pre-provisioned QoS parameters for such service flow.

Base station 104 further includes a transmitting unit configured to transmit an emergency service packet for the emergency service call to the mobile station, wherein the mobile station is identified by a GRE key received from a gateway. The emergency service packet is destined to a current mobile station IP address, if previously allocated, or to a mobile station designated emergency service IP address that is different from a network designated emergency IP address.

When base station 104 receives an emergency service indication in the DSA-REQ request and/or a data packet with the network emergency services designated IP address, base station 104 may create a corresponding service flow/datapath for the call with ASN-GW 206. Alternatively, there may be one or more pre-established service flows and datapaths for emergency services purposes between base station 104 and ASN-FW 206. For the pre-established service flows, in the signalling messages the mobile station ID is equal to zero and additional emergency services type-length-values (TLV) may be standardized. To ensure that there is no contention in using such pre-established datapaths, emergency services TLV may include the emergency services direction, that is whether the call is a mobile station-initiated call or a PSAP-initiated call.

Hence, in the present invention, base station 104 may begin using a pre-established datapath immediately while at the same time modifying the pre-established datapath to set a correct mobile station ID and mobile station information. Such mobile station information may optionally include location information provided by mobile station 102. It should be noted that the mobile station indicated location information may not replace location information offered by base station 104. The mobile station indicated location and the base station location information are complimentary and may both be provided to upper service layers. So, in the case of a denial of service (DoS) attack, when a mobile station-based attacker decides to hide the location of the mobile station by providing false location information in the emergency service call, the base station location information may be used.

Together with using a pre-established connection to ASN-GW 206, base station 104 may initiate creating an additional and similar connection for the next emergency service call. In any case, if a pre-established connection does not exist, a new pre-established connection may be created using standard WiMAX procedure, but including the newly defined emergency services TLV, as described above. If for any reason an existing datapath cannot be modified to set a new mobile station ID, a new datapath TLV can include the pre-established datapath information as a sub-TLV, of the emergency services TLV, to allow correct mapping on both sides.

It should be noted that in any case, creation of connectivity between base station 104 and ASN-GW 206 should not fail because of lack of resources in either network element. If such resources do not exist, they may be created, for example, by taking such resources from non-emergency connections. To accommodate some timing differences for such modifications, both base station 104 and ASN-GW 206 may reserve available capacity for emergency services calls.

In an embodiment of the invention, when base station 104 has to create a new datapath to ASN-GW 206 after an emergency services data packet comes in, base station 104 may buffer the data packets, up to a pre-configured limit, until the datapath creation is completed.

ASN-GW 206 includes a receiving unit configured to receive an indication from base station 104 that a packet destined to a network emergency service designated destination internet protocol address is an implicit indication of emergency service use. ASN-GW 206 also includes an emergency service handling unit that provides prioritized handling of the packet internally in ASN-GW 206 and optionally indicates the emergency packet at the transport layer by setting proper priority/DSCP fields at L2 and/or L3 levels. ASN-GW 206 also includes a determining unit configured to determine if the mobile station is assigned an internet protocol (IP) address and a corresponding address allocation unit configured to preallocate one or more unique IP address(es) through DHCP, Radius, Mobile IP or other means for the purpose of future emergency calls. Such pre-allocated IP addresses could be either private IP addresses for communication with local PSAP or public IP addresses for use with any PSAP access including roaming scenario. ASN-GW 206 further includes a corresponding translating unit configured to translate between the mobile station emergency service designated IP address and a dynamically assigned unique IP address to be used for a particular emergency call when the IP address is not previously assigned to the mobile station. The gateway further includes a selection unit configured to select a public safety answering point in visited or home network and a corresponding translating unit configured to translate network emergency service designated IP address into the selected PSAP destination IP address

One role of ASN-GW 206 is optional handling of pre-established datapath(s) and handling of the emergency services TLV. Another role of the ASN-GW 206 is resource handling, for example handling of spare capacity for emergency services calls, and resource relocation between existing sessions to accommodate a new or an upcoming potential emergency services call, if spare resource are being used for the current emergency service call

ASN-GW 206 is also used for IP address management so that if a mobile station has not been previously assigned an IP address, the invention uses the mobile station emergency services designated IP addresses to minimize signalling and latency for emergency services call establishment. To accommodate mobile station mobility during an emergency service call, one embodiment of the present invention may use the standardized Proxy mobile IP (MIP) infrastructure, which is mandatory in ASN-GW 206 as per WiMAX Release 1 specification. In this case, the Proxy mobile IP (PMIP) may request (ahead of time in case of pre-allocation or during emergency call if no pre-allocated address exists) the home address (HoA) on behalf of the mobile station from a regular home agent 208 or a home agent dedicated for emergency services calls depending on specific operator deployment and configuration. A home agent 208 dedicated for emergency services calls may be located at a PSAP and managed by the PSAP. A foreign agent in ASN-GW 206, in case of IPv4, assigns a care-of address (CoA) for the mobile station and a DataPath Function associates between the corresponding datapath, CoA and HoA. Again, to minimize latency for emergency services call establishment, ASN-GW 206 may pre-established a number of such HoAs from home agent 208, with infinite lifetime, and use them when needed for emergency services purposes. All handovers may follow standard WiMAX procedures for mobile station context transfer including, emergency services information.

It should be obvious to one skilled in the art that the designated IP addresses cannot be used in regular routed networks when sending packets to the PSAP, therefore network address translation (NAT) functionality in ASN-GW 206 may be used. As is also obvious, if the mobile station has an assigned IP address, there is no need to translate the IP address in ASN-GW using NAT. When the HoA is known for emergency services call, ASN-GW may program a NAT rule to translate between the HoA and the mobile station emergency service designated IP address. To accommodate multiple simultaneous emergency calls, ASN-GW needs knowledge of a specific mobile station, but such indication is provided implicitly by base station 104 using mobile station-specific data path (with GRE key) as it is done for any other user data transport in WiMAX networks. To be able to route to a correct PSAP, ASN-GW 206 may have configured a number of PSAPs and it may choose a PSAP based on the mobile station's location and/or some load balancing mechanism between available PSAPs. One embodiment of the present invention uses base station 104 ID that was involved in establishment of emergency services call. The selected PSAP may not change even if the mobile station moves. Therefore, in an embodiment of the invention, the PSAP selection and corresponding address translation rules become a part of mobile station's context and must be transferred during handover.

If the mobile station had requested connection to the home PSAP and subscriber information is available in ASN-GW 206, and the home PSAP is provided in the subscriber profile, ASN-GW 206 can select the home PSAP, assuming that the home PSAP has a public IP address. When the PSAP is selected, ASN-GW 206 replaces the home network emergency services designated IP destination address in the user packet with IP address of the PSAP. It is obvious that ASN-GW 206 may perform reverse NAT function in downlink direction. Hence, all NAT rules must be part of the subscriber context passed during handovers.

If ASN-GW 206 cannot immediately forward an emergency service data packet, for example, Mobile IP registration is in progress when an emergency services data packet arrives in ASN-GW 206, ASN-GW 206 may buffer such data packets, up to a pre-configured limit, until forwarding to the PSAP is available. ASN-GW 206 may also cooperate in potential QoS update for emergency services service flow, location information and mobile station information sharing with PSAP. In one embodiment of the invention, ASN-GW may perform complimentary signalling to selected PSAP and provide additional information about the mobile station and subscriber.

An embodiment of the invention relates to a method that includes universal emergency services calling functionality all over the world through the means of network emergency services designated destination IP address. The method includes also identification of emergency services call by means of using network emergency services designated destination IP address. The method also includes translation between network emergency services designated IP address and the selected PSAP for this particular emergency services call handling.

An embodiment of the invention also relates to a method that includes capability to connect to either visited or home emergency services by means of using different network emergency services designated destination IP address for home and visited PSAP access. The method also includes indication of mobile station preference for selection of visited or home emergency services by means of using different network emergency services designated destination IP address for these two cases. The method also includes selection between visited and home emergency services based on mobile station preferences indication. The method also includes enforcing of connectivity to visited emergency services when mobile station preference indicated desire to be connected to home emergency services and such connection is not possible for any reason.

An embodiment of the invention also relates to a method that includes minimized network signalling at the time of actual emergency call establishment by means of using the pre-established data paths and other network resources for connectivity between access service network and corresponding visited PSAP or frequently used home PSAP. The method also includes mapping of these pre-established data paths or other network resources for the specific emergency call usage. The method also includes falling back to establish network data paths and reserve other network resources when there are no more pre-established data paths and other network resources available because of higher than expected rate of emergency services calls or any other reason.

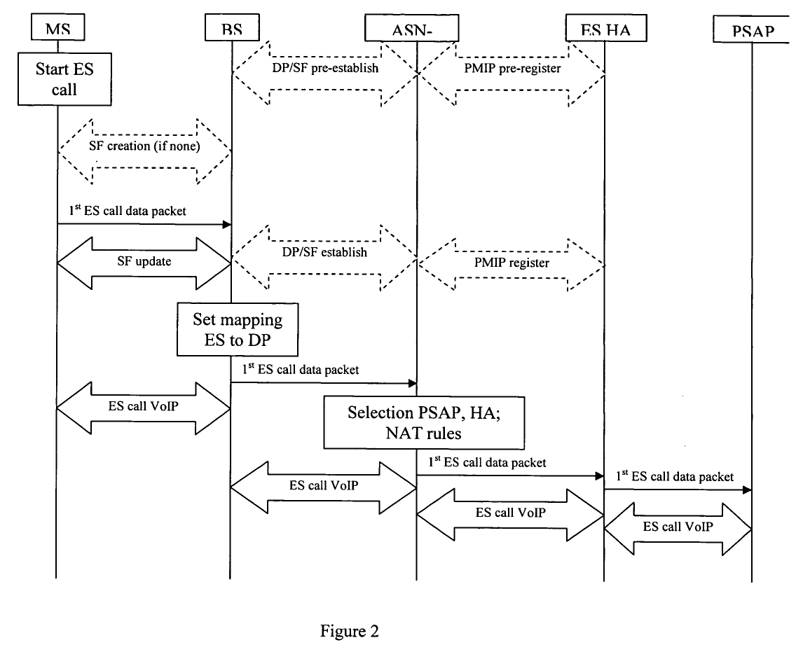

FIG. 2 illustrates a data flow diagram implementing the steps implemented in embodiments of the invention. In Step 2010, there may be one or more pre-established service flows and datapaths for emergency services purposes between base station 104 and ASN-FW 206 and the Proxy mobile IP (PMIP) may request the home address (HoA) on behalf of the mobile station from a home agent 208 dedicated for emergency services calls. In Step 2020, a initial service flow is established between mobile station 102 and base station 104. In Step 2030, an emergency service request is sent in a data packet from mobile station 102 to base station 104. In Step 2040, when base station 104 receives the emergency service indication in the DSA-REQ request and/or a data packet with the network emergency services designated IP address, base station 104 creates corresponding service flow and datapath for the call with ASN-GW 206 and updates the service flow with mobile station. PMIP registration also occurs between ASN-GW 206 and home agent 208, if not done ahead of the call. In Step 2050, the first packet for emergency call is sent from base station 104 to ASN-GW 206. In Step 2060, emergency services call voice over IP is enabled between base station 104 and mobile station 102. The PSAP is selected and NAT may be implemented, if needed. In step 2070, the first packet for emergency call is sent from ASN-GW 206 to home agent 208 and from home agent to the PSAP and emergency services calls voice over IP is enabled between ASN-GW 206 and base station 104, between ASN-GW 206 and home agent 208, and between home agent 208 and the PSAP.

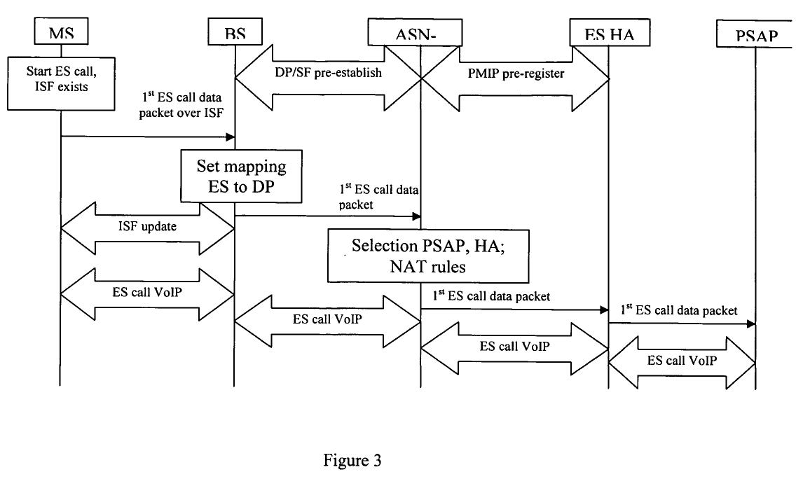

FIG. 3 illustrates a data flow diagram implementing the steps implemented in embodiments of the invention when there is an initial service flow, pre-established data paths and pre-registered mobile IP. In Step 3010, there may be one or more pre-established service flows and datapaths for emergency services purposes between base station 104 and ASN-GW 206 and the Proxy mobile IP (PMIP) may request the home address (HoA) on behalf of the mobile station from a home agent 208 (optionally dedicated for emergency services calls). In Step 3020, an emergency service request is sent in a data packet from mobile station 102 to base station 104 over the initial service flow. In Step 3030, the first call is sent from base station 104 to ASN-GW 206. In Step 3040, base station 104 updates the service flow with mobile station. In Step 3050, emergency services call voice over IP is enabled between base station 104 and mobile station 102. The PSAP is selected and NAT may be implemented, if needed. In Step 3060, the first packet for an emergency call is sent from ASN-GW 206 to home agent 208 and from home agent to the PSAP and emergency services calls voice over IP is enabled between ASN-GW 206 and base station 104, between ASN-GW 206 and home agent 208, and between home agent 208 and the PSAP.

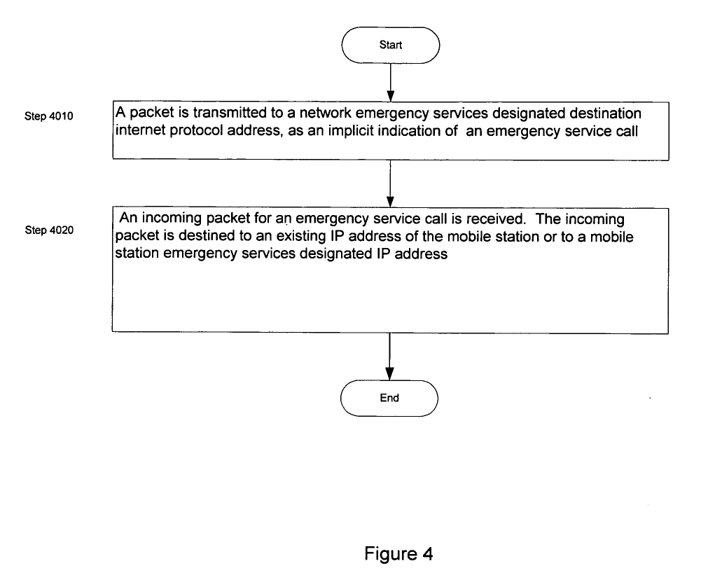

FIG. 4 illustrates the steps implemented by a mobile station implementing embodiments of the invention. In Step 4010, a packet is transmitted to a network emergency services designated destination internet protocol address, as an implicit indication of an emergency service call. In Step 4020, an incoming packet for an emergency service call is received. The incoming packet is destined to an existing IP address of the mobile station or to a mobile station emergency services designated IP address.

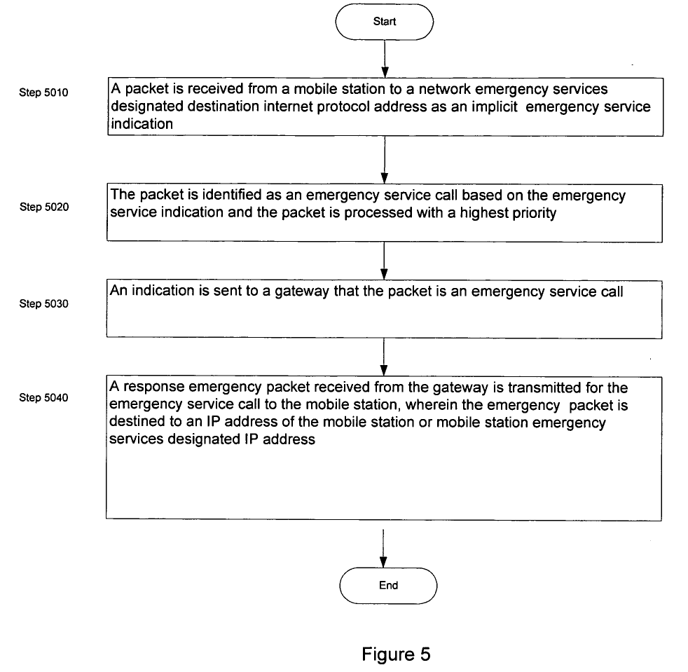

FIG. 5 illustrates the steps implemented by a base station implementing embodiments of the invention. In Step 5010, a packet is received from a mobile station to a network emergency services designated destination internet protocol address as an implicit emergency service indication. In Step 5020, the packet is identified as an emergency service call based on the emergency service indication and the packet is processed with a highest priority. In Step 5030, the packet is transmitted to a gateway. In Step 5040, a response emergency packet, received from the gateway, is transmitted for the emergency service call to the mobile station, wherein the emergency packet is destined to an IP address of the mobile station or mobile station emergency services designated IP address.

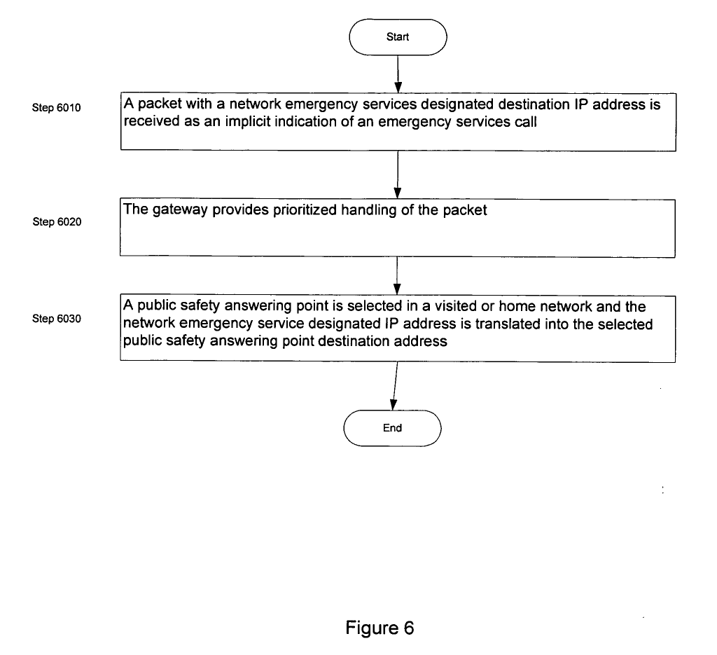

FIG. 6 illustrates the steps implemented by a gateway implementing embodiments of the invention. In Step 6010, a packet with a network emergency services designated destination IP address is received as an implicit indication of an emergency services call. In Step 6020, the gateway provides prioritized handling of the packet. 6030, a public safety answering point is selected in a visited or home network and the network emergency service designated IP address is translated into the selected public safety answering point destination address.

In the opposite direction, when a downlink packet is coming to ASN-GW 206, its source IP address is selected from one of the PSAPs. The destination IP address is an IP address allocated to mobile station. In one embodiment of the invention, the PSAP IP address is delivered to the mobile station. Therefore, further emergency calls are directed to the PSAP destination IP address from mobile station instead of to the home or visited network emergency services designated IP address. In another embodiment of the invention, the PSAP IP address is translated to the address back to home or visited network emergency services designated IP address. Hence, the expose PSAP destination IP address is not exposed to mobile station 102, thereby avoiding some potential denial of service (DoS) attacks against the PSAP. If mobile station had been allocated an IP address before the emergency call, and such IP address is known to mobile station, ASN-GW 206 would not need to translate such destination IP address. Otherwise, ASN-GW 206 translates the destination IP address into mobile station emergency services designated IP address.

ASN-GW 206 also processes such emergency packet with a highest priority and sends it to pre-established data path connection, if one exists; otherwise ASN-GW 206 buffers the packet and establishes the emergency services data path to base station 104. ASN-GW 206 may use DSCP marking for packets sent to base station 104 to ensure proper handling of the emergency packet by the network between ASN-GW 206 and base station 104. When base station 104 receives a downlink emergency services packet, base station 104 identifies the packet as an emergency packet either by means of the used emergency data path or by identifying source and/or destination IP address as a designated emergency services IP address. Base station 104 processes the message with high priority and forwards the message to mobile station 102. If there is no connection to mobile station 102 at the time of emergency services packet received, base station 104 buffers the packet, establishes the required connection through standard signalling and forwards packet immediately afterwards. When MS receives downlink emergency services packet, it should identify it as an emergency packet and process it with the highest priority either as a part of existing emergency services session or new incoming emergency call.

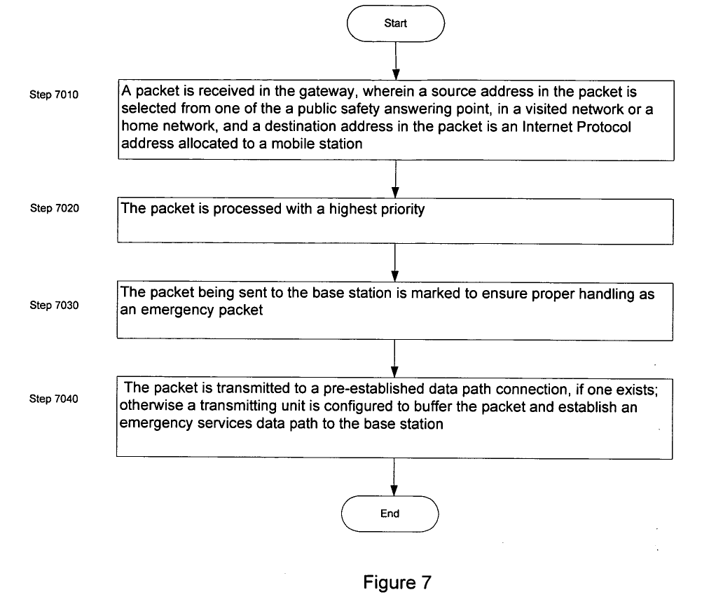

FIG. 7 illustrates the steps implemented, in a downlink direction, by a gateway implementing embodiments of the invention. In Step 7010 a receiving unit is configured to receive a packet, wherein a source address in the packet is selected from one of the a public safety answering point, in a visited network or a home network, and a destination address in the packet is an Internet Protocol address allocated to a mobile station. In Step 7020, a processing unit is configured to process the packet with a highest priority. In Step 7030, a marking unit is configured to mark the packet being sent to the base station to ensure proper handling as an emergency packet. In Step 7040, a transmitting unit is configured to transmit the packet to a pre-established data path connection, if one exists; otherwise the transmitting unit is configured to buffer the packet and establish an emergency services data path to the base station.

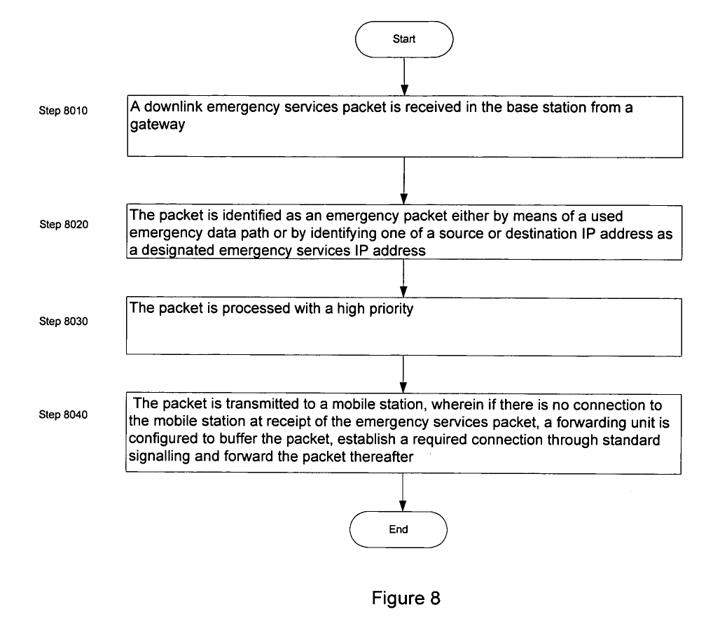

FIG. 8 illustrates the steps implemented, in a downlink direction, by a base station implementing embodiments of the invention. In Step 8010, a receiving unit is configured to receive a downlink emergency services packet from a gateway. In Step 8020, an identification unit is configured to identify the packet as an emergency packet either by means of a used emergency data path or by identifying one of a source or destination IP address as a designated emergency services IP address. In Step 8030, a processing unit is configured to process the packet with a high priority. In Step 8040, a forwarding unit is configured to forward the packet to a mobile station, wherein if there is no connection to the mobile station at receipt of the emergency services packet, the forwarding unit is configured to buffer the packet, establish a required connection through standard signalling and forward the packet thereafter.

It should be appreciated by one skilled in art, that the present invention may be utilized in any device that is implemented on a WiMAX network described above. It should be appreciated by one skilled in art, that the present invention may be utilized in other types of communications networks which use Internet Protocol and in any devices using such networks. It should be apparent to one skilled in the art that embodiments of the present invention may also be implements by software components embodied in one or more of the devices employed by networks implementing the invention.

The foregoing description has been directed to specific embodiments of this invention. It will be apparent; however, that other variations and modifications may be made to the described embodiments, with the attainment of some or all of their advantages. Therefore, it is the object of the appended claims to cover all such variations and modifications as come within the true spirit and scope of the invention.

What is claimed:

1. A mobile station, comprising:
a transmitting unit configured to transmit a packet to a network emergency services designated destination internet protocol address, wherein the packet includes a request with an emergency service indication; and
a receiving unit configured to receive an incoming packet for an emergency service call, wherein the incoming packet is destined to a destination address of the mobile station and wherein the destination address of the incoming packet is one of a mobile station designated emergency service Internet Protocol (IP) address or a current IP address of the mobile station, if previously allocated,
wherein the receiving unit is configured to receive the incoming packet through a service flow and the mobile station is thereby configured to minimize signalling with a network before the mobile station begins an emergency service call.

2. The mobile station of claim 1, wherein the transmitting unit is configured to transmit the packet based on an end user action on the mobile station and wherein the network emergency services designated destination internet protocol address is an indication of emergency service.

3. The mobile station of claim 1, wherein the receiving unit is configured to receive the incoming packet which is directed to the network emergency services designated IP address which is standardized in other network components.

4. The mobile station of claim 1, wherein the receiving unit is configured to receive the incoming packet through one of an initial service flow or a separate service flow.

5. The mobile station of claim 4, wherein the mobile station comprises a setting unit configured to accept requests for quality of service settings for the initial service flow or the separate service flow.

6. The mobile station of claim 1, wherein the mobile station comprises an access unit configured to access at least one of a home public safety answering point or a visited public safety answering point by transmitting a request to one of the home public safety answering point or the visited public safety answering point.

7. The mobile station of claim 6, wherein the access unit is configured to access the home public safety answering point when the mobile station is authenticated with a home network and the home public safety answering point is provided as a part of a profile associated with a mobile subscriber.

8. A base station, comprising:
a receiving unit configured to receive a packet from a mobile station to a network emergency services designated destination internet protocol (IP) address, wherein the packet includes a request with an emergency service indication;
an identifying unit configured to identify the packet as an emergency service call based on the emergency service indication;
an emergency packets handling unit configured to process emergency packets with a highest priority;
an indication unit configured to indicate to a gateway that the packet is an emergency service call; and
a transmitting unit configured to transmit a response emergency packet for the emergency service call, received from the gateway, to the mobile station, wherein the emergency packet is destined to a current mobile station IP address or to a mobile station designated emergency service IP address which is different from network emergency services designated IP address.

9. The base station of claim 8, wherein the indicating unit is configured to make a gateway indication implicit by forwarding the packet with the network emergency services designated destination address to the gateway through the means of at least one of a priority field or a DSCP field use or configured to make the gateway indication explicit by using a preconfigured service flow that is dedicated for emergency packets, and
wherein the indicating unit is configured indicate requests for at least one of a home public safety answering point or a visited public safety answering point to the gateway.

10. The base station of claim 8, wherein the transmitting unit is configured to transmit the response packet through one of an initial service flow or a separate service flow.

11. The base station of claim 10, wherein the base station comprises a setting unit configured to set quality of service parameters for the initial service flow or the separate service flow.

12. The base station of claim 8, wherein the base station comprises a creation unit configured, upon receiving the packet, to create a corresponding service flow or a data path for an emergency service call to the gateway.

13. The base station of claim 8, wherein the base station comprises a creation unit configured to create pre-established service flows and data paths for emergency service calls to the gateway, wherein in a signalling message on a pre-established flow, a mobile station identifier is set to zeros and an emergency service parameter is standardized.

14. The base station of claim 8, wherein the base station comprises a buffer unit configured, upon receiving the packet, to buffer a predefined number of data packets until a new data path is created with the gateway.

15. A gateway, comprising:
a receiving unit configured to receive an indication from a base station to a network emergency service designated destination internet protocol (IP) address, wherein the network emergency service designated destination IP address is an implicit indication of emergency service use;
an emergency service handling unit configured to provide prioritized handling of the packet internally in the gateway;
a selection unit configured to select a public safety answering point in a visited network or a home network and a corresponding translation unit configured to translate network emergency service designated IP address into the selected public safety answering point destination IP address.

16. The gateway of claim 15, wherein the selection unit is configured to select the public safety answering point based on at least one of the location of the mobile station or a request by the mobile station.

17. The gateway of claim 15, wherein the gateway further comprises:
a determining unit configured to determine if the mobile station is assigned an IP address;
an address allocation unit configured to pre-allocate one or more unique IP addresses for emergency calls; and
a translating unit corresponding to the address allocation unit configured to translate a mobile station emergency service designated IP address and a dynamically assigned unique IP address used for a particular emergency call, when a IP address is not previously assigned to the mobile station.

18. A method, comprising:
transmitting a packet to a network emergency services designated destination internet protocol address, wherein the packet includes a request with an emergency service indication; and
receiving an incoming packet for an emergency service call, wherein the incoming packet is destined to a destination address of the mobile station and wherein the destination address of the incoming packet is one of a mobile station designated emergency service (Internet Protocol) IP address or a current IP address of the mobile station, if previously allocated, wherein the incoming packet is received through a service flow and the mobile station is thereby configured to minimize signalling with a network before the mobile station begins an emergency service call.

19. The method of claim 18, wherein the transmitting comprises transmitting the packet based on an end user action on the mobile station, wherein the network emergency services designated destination internet protocol address is an indication of emergency service.

20. The method of claim 18, wherein the receiving comprises receiving the incoming packet which is directed to the network emergency services designated IP address which is standardized in other network components.

21. The method of claim 18, wherein the receiving comprises receiving the incoming packet through one of an initial service flow or a separate service flow.

22. The method of claim 20, further comprising accepting requests for quality of service settings for the initial service flow or the separate service flow.

23. The method of claim 18, further comprising accessing at least one of a home public safety answering point or a visited public safety answering point by transmitting a request to one of the home public safety answering point or the visited public safety answering point.

24. The method of claim 22, further comprising accessing the home public safety answering point when the mobile station is authenticated with a home network and the home public safety answering point is provided as a part of a profile associated with a mobile subscriber.

25. A method, comprising:
receiving a packet from a mobile station to a network emergency services designated destination internet protocol (IP) address, wherein the packet includes a request with an emergency service indication;
identifying the packet as an emergency service call based on the emergency service indication;
processing emergency packets with a highest priority;
indicating to a gateway that the packet is an emergency service call; and
transmitting a response emergency packet for the emergency service call, received from the gateway, to the mobile station, wherein the emergency packet is destined to a current mobile station IP address or to a mobile station designated emergency service IP address which is different from network emergency services designated IP address.

26. The method of claim 25, wherein indicating comprises:
making a gateway indication implicit by forwarding the packet with the network emergency services designated destination address to the gateway through the means of at least one of a priority field or a DSCP field use or making the gateway indication explicit by using a preconfigured service flow that is dedicated for emergency packets, and
indicating requests for at least one of a home public safety answering point or a visited public safety answering point to the gateway.

27. The method of claim 25, wherein transmitting comprises transmitting the response packet through one of an initial service flow or a separate service flow.

28. The method of claim 25, further comprising setting set quality of service parameters for the initial service flow or the separate service flow.

29. The method of claim 25, further comprising creating, upon receiving the packet, a corresponding service flow or a data path for an emergency service call to the gateway.

30. The method of claim 25, further comprising creating pre-established service flows and data paths for emergency service calls to the gateway, wherein in a signalling message on a pre-established flow, a mobile station identifier is set to zeros and an emergency service parameter is standardized.

31. The method of claim 25, further comprising buffering, upon receiving the packet, a predefined number of data packets until a new data path is created with the gateway.

32. A method, comprising:
receiving an indication from a base station to a network emergency service designated destination internet protocol (IP) address, wherein the network emergency service designated destination IP address is an implicit indication of emergency service use;
providing prioritized handling of the packet internally in the gateway;
selecting a public safety answering point, in a visited network or a home network and translating the network emergency service designated IP address into the selected public safety answering point destination IP address.

33. The method of claim 32, further comprising selecting the public safety answering point based on at least one of the location of the mobile station or a request by the mobile station.

34. The method of claim 32, further comprising:
determining if the mobile station is assigned an IP address;
pre-allocating one or more unique IP addresses for emergency calls;
translating a mobile station emergency service designated IP address and a dynamically assigned unique IP address used for a particular emergency call, when a IP address is not previously assigned to the mobile station;

35. An apparatus, comprising:
transmitting means for transmitting a packet to a network emergency services designated destination internet protocol address, wherein the packet includes a request with an emergency service indication; and
receiving means for receiving an incoming packet for an emergency service call, wherein the incoming packet is destined to a destination address of the mobile station and wherein the destination address of the incoming packet is one of a mobile station designated emergency service Internet Protocol (IP) address or a current IP address of the mobile station, if previously allocated,
wherein the incoming packet is received through a service flow and the mobile station is thereby configured to minimize signalling with a network before the mobile station begins an emergency service call.

36. An apparatus, comprising:
receiving means for receiving a packet from a mobile station to a network emergency services designated destination internet protocol (IP) address, wherein the packet includes a request with an emergency service indication;
identifying means for identifying the packet as an emergency service call based on the emergency service indication;
processing means for processing emergency packets with a highest priority;
indicating means for indicating to a gateway that the packet is an emergency service call; and
transmitting means for transmitting a response emergency packet for the emergency service call, received from the gateway, to the mobile station, wherein the emergency packet is destined to a current mobile station IP address or to a mobile station designated emergency service IP address which is different from network emergency services designated IP address.

37. An apparatus, comprising:
receiving means for receiving an indication from a base station to a network emergency service designated destination internet protocol (IP) address, wherein the network emergency service designated destination IP address is an implicit indication of emergency service use;
providing means for providing prioritized handling of the packet internally in the gateway;
selecting means for selecting a public safety answering point, in a visited network or a home network and for translating the network emergency service designated IP address into the selected public safety answering point destination IP address.

38. A gateway, comprising:
a receiving unit configured to receive a packet, wherein a source address in the packet is selected from one of the a public safety answering point, in a visited network or a home network, and a destination address in the packet is an Internet Protocol address allocated to a mobile station;
a processing unit configured to process the packet with a highest priority;
a marking unit configured to mark the packet being sent to a base station to ensure proper handling as an emergency packet; and
a transmitting unit configured to transmit the packet to a pre-established data path connection, if one exists; otherwise configured to buffer the packet and establish an emergency services data path to a base station.

39. The gateway of claim 38, wherein the gateway is configured to direct an emergency call to the source address from the mobile station.

40. The gateway of claim 38, wherein the gateway is configured to translate the source address to a network emergency service designated IP address.

41. The gateway of claim 38, wherein the gateway is configured to translate the destination IP address into mobile station emergency services designated IP address, if an IP address is not allocated to the mobile station prior to the call.

42. The gateway of claim 38, wherein the marking unit is configured to use DSCP marking for packets sent to the base station

43. A base station, comprising:
a receiving unit configured to receive a downlink emergency services packet from a gateway;
an identification unit configured to identify the packet as an emergency packet either by means of a used emergency data path or by identifying one of a source or destination Internet Protocol (IP) address as a designated emergency services IP address;
a processing unit configured to process the packet with a high priority; and
a forwarding unit configured to forward the packet to a mobile station, wherein if there is no connection to the mobile station at receipt of the emergency services packet, the forwarding unit is configured to buffer the packet, establish a required connection through standard signalling and forward the packet thereafter.

44. A method, comprising:
receiving a packet, wherein a source address in the packet is selected from one of the a public safety answering point, in a visited network or a home network, and a destination address in the packet is an Internet Protocol address allocated to a mobile station;
processing the packet with a highest priority;
marking the packet being sent to a base station to ensure proper handling as an emergency packet; and
transmitting the packet to a pre-established data path connection, if one exists; otherwise configured to buffer the packet and establish an emergency services data path to a base station.

45. A method, comprising:
receiving a downlink emergency services packet from a gateway;
identifying the packet as an emergency packet either by means of a used emergency data path or by identifying one of a source or destination Internet Protocol (IP) address as a designated emergency services IP address;
processing the packet with a high priority; and
forwarding the packet to a mobile station, wherein if there is no connection to the mobile station at receipt of the emergency services packet, the forwarding unit is configured to buffer the packet, establish a required connection through standard signalling and forward the packet thereafter.
